(19) United States
(12) Patent Application Publication
(10) Pub. No.: US 2025/0089736 A1
(43) Pub. Date: Mar. 20, 2025

(54) EXTRACTION OF COFFEE OIL FROM SPENT COFFEE GROUNDS USING MECHANICAL HYDRAULIC PRESS AND PURIFICATION THEREOF

(71) Applicant: KAFFA KUWWA INNOVATIONS PVT. LTD., West Bengal (IN)

(72) Inventors: Sanghamitra SEAL, Calcutta (IN); Pratish MONDAL, Calcutta (IN); Prasanta Kumar BISWAS, Kolkata (IN)

(73) Assignee: KAFFA KUWWA INNOVATIONS PVT. LTD., West Bengal (IN)

(21) Appl. No.: 18/884,234

(22) Filed: Sep. 13, 2024

(30) Foreign Application Priority Data
Sep. 20, 2023 (IN) 202331063040

(51) Int. Cl. A23F 5/48; A23F 5/18; A23F 5/28

(52) U.S. Cl. CPC A23F 5/48; A23F 5/18; A23F 5/285

(57) ABSTRACT

Provided herein is a method for extraction of crude coffee oil (CCO) from spent coffee ground (SCG) using Mechanical Hydraulic Press Machine. The extraction includes a preliminary step of reducing moisture content of the raw material followed by mechanical extraction of the spent coffee ground to obtain crude coffee oil. Also provided herein is a chemical-free method for purification of crude coffee oil to obtain pure coffee oil.

### CROSS-REFERENCE TO RELATED APPLICATIONS

This application claims the benefit under 35 U.S.C. § 119(a) of Indian Patent Application No. 202331063040 filed Sep. 20, 2023, the contents of which are incorporated by reference herein in their entirety.

### BACKGROUND

### 1. Field of the Disclosure

The present disclosure relates to the mechanical extraction of Crude Coffee Oil (CCO) from Spent Coffee Grounds (SCG) and chemical free purification thereof. The disclosure especially relates to mechanical extraction and chemical free purification of Crude Coffee Oil (CCO) from ground coffee beans which have already been used to brew coffee.

### 2. Description of the Related Art

Coffee is a global consumer product. Coffee is in commercial use not only as a popularly loved beverage, but is known for its antioxidant properties, its role in aiding digestion, liver function, heart health and brain health. Coffee is a good alternative to energy drinks. According to incomplete statistics, the annual global coffee consumption is about 8 million tons, and it grows at an annual rate of 1.5%. The Coffee Carbon Footprint from 2 billion cups of Coffee, consumed in the world daily, emit 56-80 Crore Kgs of CO₂ and therefore significantly impacts Climate Change. The rising temperature is reducing the coffee growing in tropical highland regions by 50%, putting the €458 billion Global Coffee Market into jeopardy as reported in https://www.statista.com/outlook/cmo/hot-drinks/coffee/worldwide. Along with the Coffee Market, the redrawn coffee map poses devastating risks to economies like Mexico, El Salvador, Nicaragua, Brazil, India & Madagascar and to the livelihood of Coffee Farmers, 70% of whom run small operations.

Spent coffee ground can be used to extract oil, potent with anti-oxidative and anti-inflammatory properties that protect against chronic illnesses and diseases. The extraction of unrefined oil from coffee ground is used directly for soap making. They also aid in augmenting respiratory and skin health. It has been evidenced that using diluted coffee oil can help with age spots, blemishes and wrinkles.

TW102149170A relates to an extract for recovering coffee grounds and a preparation method as the first aspect of the disclosure; wherein the aqueous phase extraction is carried out by mixing the recovered coffee ground refined powder with pure water in a ratio of 1:3, by cooking. Extraction was carried out by super critical fluid extraction, ultrasonic or microwave extraction.

U.S. Pat. No. 98,224,822 relates to a method for preparing a functional film via coffee oil and comprising (a) extracting a coffee oil from coffee; (b) modifying the coffee oil to obtain an epoxidized coffee oil; (c) adding an alcohol into the epoxidized coffee oil to obtain a coffee polyol; (d) synthesizing a polyurethane dispersive solution with the coffee polyol; (e) coating a surface of a substrate with the polyurethane dispersive solution; and (f) drying and fixing the surface of the substrate. The prior art document further provides a functional textile comprising a functional film prepared by the method of above.

U.S. Ser. No. 11/667,868B2 belongs to the field of chemical processes and consists of an extraction method for producing clarified coffee oil from coffee grounds and from whole and/or damaged beans. The process comprises stages of inoculation and incubation of SCG or the coffee beans with macromycetes, thus achieving to eliminate the typical brown color of the coffee and thus obtain clarified coffee oil.

WO2021069749A2 relates to a method and apparatus for storing and preserving biomass Spent Coffee Grounds (SCG) on-site, prior to collection and other biomass. The system stores and preserves biomass, comprising: a bin (2) with an opening (3) for receipt of biomass; an openable lid (4) for the bin configured to hermetically seal the opening when closed, a biopreservative dispenser (12, 15, 18, 51) configured to dispense biopreservative on the biomass inside the bin upon actuation; and an actuation system for the biopreservative dispenser configured to automatically actuate the biopreservative dispenser.

US2020/0270539 A1 relates to a biofuel, particularly an advanced solid biofuel, comprising SCG. The disclosure focuses on making a Solid Biofuel that has a certain proportion of SCG, along with other materials required to make the biofuel.

U.S. Pat. No. 5,910,454 relates to a solid burnable fuel composition which contains a major proportion of spent dried coffee grounds for forming into high density pellets, synthetic fire logs, and fire kindling products.

Solvent extraction process and super critical fluid extraction process are the two conventional processes known for extraction of coffee oil. The solvent extraction process involves use of hexane as solvent, which is costly and toxic in nature and further causes damage to the environment. Further, in high-pressure super critical fluid extraction process the solid samples are used in presence of CO₂ and the solution is discharged to high temperatures up to 200° C. above the boiling point by the short-term high-pressure application. The high temperature and pressure used in such a process involves high-cost setup and therefore is a highly expensive process.

Accordingly, there is a requirement for an economic, natural, eco-friendly and chemical free process for extraction of coffee oil from spent coffee ground which generates the minimum amount of end waste and thereby reduces the burden on the environment.

### SUMMARY

Accordingly, it is an object of the present disclosure to provide a natural chemical free process for extraction of Crude Coffee Oil and the purification thereof to obtain Pure Coffee Oil.

It is further an object of the present disclosure to provide a process for production of pure coffee oil from spent coffee grounds (SCG) involving a mechanical extraction followed by chemical free purification process.

It is also an object of the present disclosure to provide an economic process for extraction and production of coffee oil from spent coffee grounds through minimal consumption of energy.

It is another object of the present disclosure to provide a process for mechanical extraction of coffee oil by Mechanical Hydraulic Press.

It is yet another object of the present disclosure to provide a chemical free purification process of crude coffee oil obtained from mechanical extraction of spent coffee grounds.

The following disclosure presents a simplified summary of the disclosure in order to provide a basic understanding of some aspects of the disclosure. This summary is not an extensive overview of the present disclosure. It is not intended to identify the key/critical elements of the disclosure or to delineate the scope of the disclosure. Its sole purpose is to present some concept of the disclosure in a simplified form as a prelude to a more detailed description of the disclosure presented later.

In an aspect of the present disclosure there is provided a process for extraction of crude coffee oil (CCO) from spent coffee ground (SCG) using Hydraulic Press Machine, the process comprising the steps of:
a. reducing moisture content of the raw material to obtain a SCG raw material having 19-26% moisture content; and
b. extracting the SCG raw material obtained at the end of step (a) to produce crude coffee oil,
wherein extraction of the SCG raw material involves compression of SCG raw material obtained at the end of step (a) at a pressure of about 400-600 bars and at a temperature of 36-39° C.

In a further aspect of the present disclosure there is provided a process for production of pure coffee oil (PCO) from Crude Coffee Oil (CCO), the process comprising the steps of: c. purifying the crude coffee oil to obtain pure coffee oil (PCO) which comprises
i. decanting by heating of CCO at 35-45° C. for a period of 20-25 minutes, to obtain three separate layers of semi purified coffee oil, moisture and coffee dust and other semi-soling gum/wax particles within the vessel,
ii. filtering the semi purified coffee oil through multiple mesh filters having mesh size between 150 to 800 to produce semi purified coffee oil, and
iii. non thermal drying of filtered semi purified coffee oil by passing the semi purified coffee oil over concentrated anhydrous sulphuric acid (H₂SO₄) and silica gel to obtain the purified coffee oil.

### BRIEF DESCRIPTION OF THE DRAWINGS

FIG. 1 illustrates SCG Oil Extraction of CCO & Purification of CCO to PCO Process Flow Diagram.

FIG. 2 illustrates Mild Steel Decanting Vessel for CWS Discharge.

FIG. 3 illustrates Custom Built Stainless Steel Netted Tray Dryer.

FIG. 4 illustrates Custom Built Mechanical-Hydraulic Press Extraction Machine.

FIG. 5 illustrates schematic Diagram of Equipment used in the Purification Process of CCO to PCO.

### DETAILED DESCRIPTION

The present disclosure provides a process for extraction of crude coffee oil from spent coffee ground and further purifying the crude coffee oil into pure coffee oil.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

It is to be understood that the singular forms “a”, “an”, and “the” include plural referents unless the context clearly dictates otherwise. Thus, for example, reference to “a component surface” includes reference to one or more of such surfaces.

The terminology used herein is for the purpose of describing particular various embodiments only and is not intended to be limiting of various embodiments. It will be further understood that the terms “comprises” and/or “comprising” used herein specify the presence of stated features, integers, steps, operations, members, components, and/or groups thereof, but do not preclude the presence or addition of one or more other features, integers, steps, operations, members, components, and/or groups thereof. Also, expressions such as “at least one of,” when preceding a list of elements, modify the entire list of elements and do not modify the individual elements of the list.

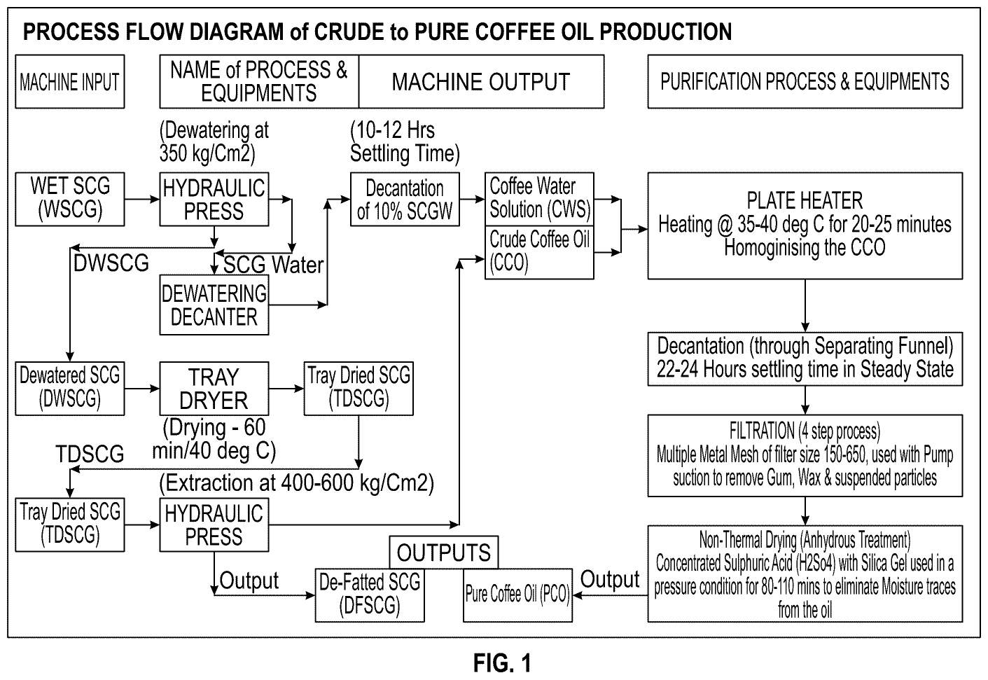

The FIG. 1 depicts the process flow of Crude Coffee Oil (CCO) extraction from Spent Coffee Ground (SCG) using a Mechanical-Hydraulic Press Machine and Stabilization of the same to Pure Coffee Oil (PCO) using a Chemical Free, non-invasive Purification Process.

In an embodiment of the present disclosure, there is provided a natural chemical free process for extraction of crude coffee oil from spent coffee ground consuming much less energy.

The present disclosure provides a mechanical process for extraction of crude coffee oil from spent coffee ground through a mechanical hydraulic press.

The mechanical hydraulic press machine is known to work in material having particle size more than 200 microns. However, the present inventors have designed a mechanical hydraulic press machine and its methodology in a way to accommodate materials (SCG) raw material having particle size less than 200 microns.

The mechanical process for extraction of crude coffee oil from spent coffee ground comprises a preliminary necessary step for preparing the spent coffee ground (SCG) raw material for the extraction of crude coffee oil through a mechanical hydraulic press machine.

The SCG raw material contains about 46-66% moisture, depending upon the method used in brewing the dry coffee bean grounds, e.g. Hot Brew, Cold Brew, French Press, Pour Over etc.

The mechanical process for extraction of crude coffee oil from spent coffee grounds comprises a step A. Reduction of moisture content of the raw material. The step A. Reduction of the moisture content of the raw material, comprises steps for reducing the moisture of the SCG raw material to obtain a feed material ready for mechanical hydraulic press.

The feed material is SCG raw material having moisture level in a range of about 46-66%.

The step A. Reduction of the moisture content of the raw material, further comprises two steps of operations:
i. dewatering and
ii. drying.

The reduction of the moisture content of the SCG raw material in the (i) step of dewatering, comprising pressing of the SCG raw material at a controlled pressure ranging between 200-400 bars for approximately an hour in the Mechanical Hydraulic Press Machine. The dewatering decanter vessel is used to collect the dewatered output and gather the Coffee Water Solution (CWS) from this vessel after a resting/settling time of 10-12 hours.

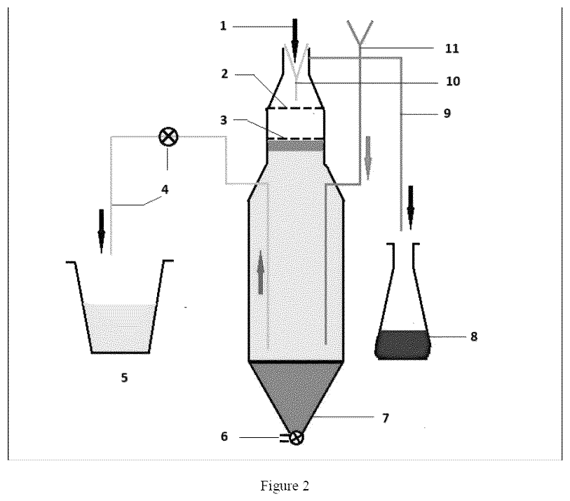

A dewatering decanter is a cylindrical steel vessel of 2.5 to 3 L capacity tapered at both ends as shown in the FIG. 2 and represented by its component keys. A decanting vessel, comprises features of SCG water input (1), rest time fluid level (2), run time fluid level (3), overflow SCG water line with valve (4), overflow SCG water collection (5), drain valve with drain line (6), gum, wax and dust settlement area (7), 10% CWS collection (8), CWS outlet (9), SCG water input through funnel (10), and water pouring line with funnel (11).

The top end has a cylindrical opening while at the bottom end a drain valve is fitted. Through this cylindrical opening at the top, a funnel is inserted represented as (1) which directs the CWS inside the decanter. An overflow line with a valve (4) is fitted in the decanter, the opening of which is at the end of the cylindrical portion of the cylinder. The pipeline outside the decanter is further elevated to maintain the liquid level in the cylinder at a predetermined height. The overflow line (4) empties its contents to a bucket (5) to collect the overflown SCG water. Another pipeline (9) is fitted at the end opposite to the overflow line and the height of the pipe is till the top of the decanter, while the bottom end of this pipe is at the same level as the overflow pipe. A funnel (11) inserted in this pipe at the top end allows water/liquid to be poured inside the decanter so as to fill the decanter from the bottom end. A third pipeline (6) is fitted just below the top of the decanter which descends alongside the decanter and is open at both ends. This is the CCO/CWS drain line (6) and the CCO/CWS is collected in a glass conical flask (8). The decanter is fitted with suitable stands and is placed in an appropriate way to collect the CWS flowing from the collection tray of the mechanical-hydraulic press machine. The operational step (i) dewatering releases about 25-37% of water from the SCG raw material to produce the SCG raw material containing about 20-28% moisture content. The dewatered SCG raw material is subjected to step (ii) drying to further reduce the moisture content and bring the raw material to have the moisture level of 19-26%.

The step (ii) drying to reduce the moisture content of SCG raw material comprises drying of the dewatered SCG (DWSCG) raw material as obtained at the end of step (i), for around 60 minutes at a minimal temperature of about 36-39° C. in a custom-made Tray Dryer.

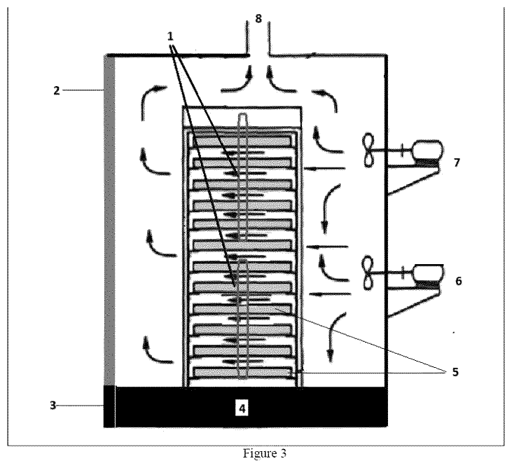

The FIG. 3 represents a custom-built tray dryer represented by its component keys and is used for the drying process of the DWSCG generated as an output of the dewatering process of the wet SCG. A tray dryer as shown comprises electrical heaters (1), door (2), electrical panel containing digital timer and temperature control, fan and heater switches (3), electrical circuitry (4), perforated trays (5), fan 1 (6), fan 2 (7), and moist air exhaust vent (8). A specifically designed Tray Dryer consisting of 12 (Twelve) netted steel trays of size 20″×20″ is used for the drying process. The base of the Trays is netted to allow for convection of hot air inside the dryer. There are two Heaters of 1.5 kVA each, installed on either side of the dryer and positioned between specific trays a) 3 & 6 and b) 7 & 10; there are two fans of 1.25 kVA capacity, on the back wall of the machine to accomplish a homogenous drying of the DWSCG. There is an additional air discharge valve on top of the dryer to expel the moist air. The size of the opening of this valve can be controlled, thus air flow out of the machine is regulated, as per the necessity of the batch's raw material type, which is less than 200 microns and contains moisture of around 65%.

The step (ii) drying of dewatered SCG raw material at the temperature of about 36-39° C. for about 60 minutes, retains the necessary moisture in the material. Higher temperature renders the dewatered SCG raw material over dry and burnt.

Thus, the present disclosure provides a process for extraction of crude coffee oil from spent coffee ground in a mechanical hydraulic press which comprises the following steps:
A. Reduction of moisture content of the raw material comprises the steps of:
   i. dewatering of SCG raw material having a moisture level of about 46-66% at a controlled pressure of about 200-400 bars for about 1 hour, to produce dewatered SCG raw material having 20-28% moisture content, and
   ii. drying of dewatered SCG raw material as obtained in step (i) at a minimal temperature of about 36-39° C. for about 60 minutes to produce dried SCG (TDSCG) raw material having 19-26% moisture content.

The mechanical process for extraction of crude coffee oil from spent coffee ground further comprises a step B. Extraction of crude coffee oil.

The step B: Extraction of crude coffee oil, comprises compression of the dewatered and dried SCG raw material (TDSCG) in a mechanical hydraulic press machine at an appropriate hydraulic pressure and temperature.

The step B: Extraction of crude coffee oil, comprises compressing dewatered and dried SCG raw material at a pressure of about 400-600 bars and at a controlled temperature of 36-39° C.

The compression of the dewatered and dried SCG raw material at a pressure less than 400 bars, does not yield crude coffee oil at an optimum quantity.

The compression of the dewatered and dried SCG raw material at a pressure higher than 600 bars, spoils the oil quality parameters.

The present disclosure therefore provides a process for extraction of crude coffee oil from spent coffee ground in a mechanical hydraulic press which comprises steps:
A. Reduction of moisture content of the raw material to obtain a SCG raw material having 19-26% moisture content,
B. Extraction of the SCG raw material obtained at the end of step A to produce crude coffee oil,
wherein the step A, reduction of moisture content of the raw material involves steps of:
   i. Dewatering of SCG raw material having a moisture level of about 46-66% at a controlled pressure of about 200-400 bars for about 1 hour, to produce dewatered SCG raw material having 20-28% moisture content, and
   ii. Drying of dewatered SCG raw material as obtained in step (i) at a minimal temperature of about 36-39° C. for about 60 minutes to produce dried SCG raw material having 19-26% moisture content; and
wherein the step B, Extraction of the SCG raw material, involves compression of SCG raw material obtained at the end of step A at a pressure of about 400-600 bars and at a controlled temperature of 36-39° C. in a mechanical hydraulic press machine.

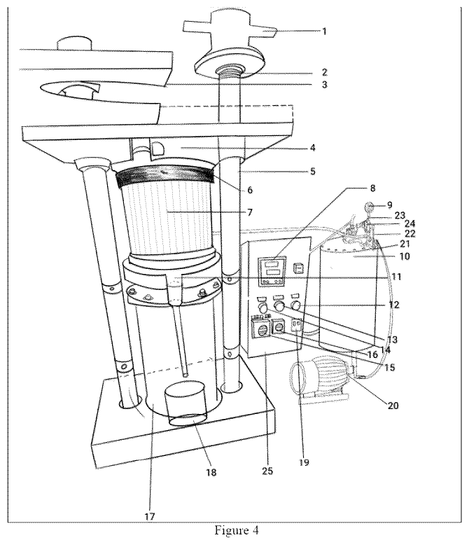

FIG. 4 represents a mechanical hydraulic press machine used for the extraction process for the generation of CCO from Tray Dried SCG (TDSCG) and is further represented with its various parts with reference numerals.

The mechanical hydraulic press machine as shown in FIG. 4 comprises threaded lock nut (1), threading on support (2), top cover (3), top cover plate (4), right support (5), band heater (6), slotted compression chamber (7), digital display and control panel of temperature control (8), pressure gauge (9), hydraulic oil tank (10), oil collection tray (11), mains indicator light (12), heater indicator light (13), motor indicator light (14), motor off/on switch (15), heater off/on switch (16), hydraulic chamber (17), oil collection chamber (18), machine mains (19), induction motor with hydraulic pump (20), directional control valve (21), directional control lever (22), pressure control valve (23), pressure control knob (24), and electrical control panel (25).

The machine is fitted with necessary electrical safety systems and hydraulic safety systems to prevent damage to the machine in case of malfunction. The Hydraulic chamber (17) is of cylindrical shape and is loosely placed on a metallic base, at the bottom of the machine. A Piston of 3 Inches diameter with a flat circular steel base (inside the machine), having a diameter of almost equal to the inside diameter of the cylinder, is placed inside the chamber (17). The piston has a circular base and is tightly fitted with the help of a PU-Bucket Gasket (Internal Part), which is of the same diameter as the inside diameter of the hydraulic cylinder. The PU—bucket gasket grips the inside wall of the hydraulic cylinder when hydraulic oil is pumped into the lower portion of the hydraulic cylinder, forming two mutually exclusive zones inside the hydraulic cylinder, preventing any flow of hydraulic fluid between the two zones. When the hydraulic oil is pumped inside the hydraulic chamber at the bottom, the entire piston sub assembly moves upward; when the hydraulic oil is pumped into the upper chamber, the oil from the lower chamber is pushed out of the lower chamber, into the Hydraulic oil tank (10), moving the piston sub assembly downward. The top of the hydraulic cylinder is bolted with the bottom end of a double flanged piping arrangement while the bottom end of the compression chamber is tightly fitted with the top end of the piping arrangement. The bottom flange of the piping arrangement also serves as a partial cover for the hydraulic cylinder while the circular slot (Internal Part) in the piping arrangement provides the passage for the piston.

A circular stainless steel Oil Collection Tray (11) with a circular slot (Internal Part) in the center, is bolted onto the lower flange of the piping arrangement. This tray collects the Crude Coffee Oil (CCO) output that is discharged through the slotted walls of the compression chamber and empties the same into the collection containers. The compression chamber (7), cylindrical in shape with a slotted outer wall is tightly fitted at the bottom to the piping arrangement, while the top end is tightly fitted to the top cover plate (4). The top cover plate (4) has a circular slot whose diameter matches the outer diameter of the top end of the compression chamber (7). The top cover plate (4) is also screwed onto the cylindrical pipe support pillars (5) and provides a base for the top cover (3). The band heater (6), fitted with a shroud, is wound onto the outer surface of the compression chamber (7) and the ends are fastened by bolts to fit snugly onto the slotted cylinder. The Piston (Internal Part) passes through the piping arrangement, into the compression chamber (7). A circular steel plate called the Compression Plate (Internal Part) is screwed onto the Piston Shaft (Internal Part); this provides the mechanism of compression inside the compression chamber. The compression chamber top is tightly fitted onto the top plate, which has a circular slot. The top plate is supported by two cylindrical pipe supports. The top cover is supported by the top cover plate (4), which rotates about one of the piped supports, while a cyclical slot slides onto the other piped support. The ends of the threaded pipe supports (2) and the threaded lock nuts (Part No. 1) tighten the Top cover.

The machine is supplied with a digital display machine main control panel as machine mains (19) which incorporates the Digital Display Temperature Control Panel (8), the Mains Indicator Light (12), the Heater Indicator Light (13), the Motor Indicator Light (14), the Motor On/Off Switch (15), Heater On/Off Switch (16). Additionally, the Pressure Gauge, the Pressure Control Valve (23) & Pressure Control Knob (24), along with the Directional Control Valve (21) & Direction Control Lever (22), are mounted on the Hydraulic Oil Tank (10). The Oil Collection Decanter (18) is placed below the delivery end of the Oil Collection Tray (10).

The process for extraction of crude coffee oil from spent coffee ground in a mechanical hydraulic press is executed for about 3-4 cycles to yield the maximum possible output of CCO of about 6.24-7.40% on a wet weight basis and about 8.94-10.24% on a dry weight basis.

The process for extraction of crude coffee oil from spent coffee ground in a mechanical hydraulic press comprises a step of releasing of pressure to neutralize to ZERO at an interval of time.

The process for extraction of crude coffee oil from spent coffee ground in a mechanical hydraulic press comprises a step of releasing the pressure of 400-600 bars in the mechanical hydraulic press to neutralize to ZERO at each cycle at every 20-25 minutes.

This step of release of pressure at each cycle of extraction is mandatory to create a churn inside the hydraulic press to create oil channels in the SCG raw material and release of CCO from the raw material along with the still remaining moisture.

The step of releasing the pressure if not executed properly, either by human error, or by mechanical error, the oil remains stuck inside the mechanical hydraulic press and as a result no oil is obtained.

In an embodiment of the present disclosure there is provided a process for stabilization and purification of crude coffee oil obtained from spent coffee ground extracted in a mechanical hydraulic press.

In the purification process of stabilizing the Crude Coffee Oil (CCO) to Pure Coffee Oil (PCO), certain particles present in the crude oil are successfully removed and cleared to achieve the purity of the oil. These particles vary depending on the bean type, its quality, nature of the process deployed to generate the SCG from the coffee beans, i.e. Cold Brew, Hot Brew, French Press, Pour Over, the extraction run time and the stages of extraction.

Some commonly identified particles in the crude coffee oil include small particles of coffee ground, which get released in the extraction process, and thereby present in the CCO; significant amount of moisture remains in the CCO.

The process for stabilization and purification of crude coffee oil purification comprises the steps of:
1. Decantation,
2. Filtration and
3. Non-Thermal Drying.

The process for stabilization and purification of crude coffee oil involving the step (1) decantation comprising heating the liquid output received from the steps of dewatering (CWS) followed by extraction (CCO).

The step of decantation comprises heating of the CCO obtained from mechanical hydraulic press at 35-45° C. for a period of 20-25 minutes in a decanting vessel. This step of heating is followed by allowing the material to settle in the separating funnel for a period of 22-24 hours.

The CCO attains a settlement followed by separation of oil, moisture and the other solid, wax/gum like particles to clearly distinguish three separated layers within the vessel called separating funnel. The separated and unwanted layers having moisture and solid like particles are discarded from the decanting vessel and only the oily part of CCO is retained.

The coffee oil after the decantation step is a semi-purified coffee oil which consists of 4-7% of free moisture, 2-4% of gum & wax, and 1-3% of coffee dust particles. The balance liquid contains 86-92% of semi purified Coffee Oil. The step of decantation is performed in a Separating Funnel. The process for stabilization and purification of crude coffee oil further includes a step of filtration comprising of filtration of the oil remains obtained from the separating funnel through multiple mesh filters at a specific pressure.

The filtration is a 3-4 step process, in which multiple mesh filters between 150 to 635 or up to 800 mesh sizes are used in an ascending order, in conjunction with pressure conditions, to facilitate the gradual separation and removal of the unwanted gummy, waxy and dusty particles of SCG, present in the liquid.

The coffee dust particles and some of the gummy substances are separated from the oil while passing through lower sized meshes. The wax and remaining gummy substance are removed when passed through the higher sized meshes.

The coffee oil after the decantation and filtration stages is a semi-purified oil which consists of 4-7% of free moisture, 0.15-0.25% of gum and wax, and 0.10-0.30% of fine coffee dust particles. The balance liquid contains 92-95% of semi purified Coffee Oil.

The process for stabilization and purification of crude coffee oil purification further includes a step of non-thermal drying comprising, removal of remaining traces of water from the semi purified coffee oil, by using concentrated anhydrous sulphuric acid (H₂SO₄) and silica gel.

Concentrated anhydrous Sulphuric Acid (H₂SO₄) as used is a food grade chemical which does not come in direct contact with the semi purified coffee oil in the present process. In the process of purification, the anhydrous Sulphuric Acid (H₂SO₄) is kept in a separate conical flask and circulated through a pipeline around the purification chamber to create an environment to absorb moisture.

The non-thermal drying process comprises using 99.9% pure H₂SO₄, and Silica Gel beads to reduce the free moisture present in the semi purified coffee oil, within the acceptable limit of 0.25-0.35%. This comprises passing the semi purified oil over 99.9% pure H₂SO₄, and Silica Gel beads for approximately 80 to 110 minutes.

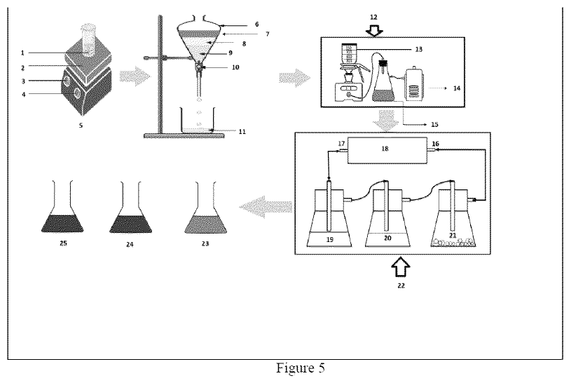

FIG. 5 represents the layout for purification process showing equipment used in the purification and stabilization of the Crude Coffee Oil (CCO) to Pure Coffee Oil (PCO).

The process layout for purification of CCO to PCO is illustrated in FIG. 4 shows its different components represented with reference numerals. The components as used in the process comprises beaker (1), heating plate (2), temperature controller (3), heating mode controller (4), plate heater (5), separating funnel (6), oil (7), wax and gum (8), water (9), stopper (10), water, wax and gum (11), vacuum filtration (12), mesh filter (13), vacuum pump (0.25 hp.) (14), oil (15), pump inlet (16), pump outlet (17), vacuum pump (0.25 hp.) (18), oil (19), sulphuric acid (20), silica gel (21), non-thermal drying (22), pure coffee oil (23), crude coffee oil (24) and coffee water solution (25).

The Equipment consists of-

Laboratory Plate heater (2): A laboratory plate heater (2) is used to uniformly heat glass vessels for tasks like sample preparation, evaporation, incubation, and chemical reactions. In this present process laboratory plate heater is used to prepare CWS and CCO ready for the Decantation purification process.

Separating Funnel (6): A separating funnel (6) is employed in the process to separate immiscible liquids with differing densities through the principle of gravity-based liquid-liquid phase separation.

Vacuum Filtration Apparatus (12): A vacuum filtration apparatus (12) is employed in this purification process to rapidly separate solid and semi-solid particles from liquids by utilizing negative pressure through a vacuum source, undergoing multiple meshes of varying sizes.

Vacuum Pump (14, 18): A 0.25 Hp vacuum pump (14, 18) is a device capable of generating moderate vacuum levels by using a 0.25 horsepower motor to remove air or gas from a sealed space. Hence the mechanism successfully helps the process in execution of the anhydrous treatment in the final stages of the purification and stabilization of PCO.

In the non-thermal drying process (22) using H₂SO₄, a closed-circuit drying unit comprising of 3 conical flasks and an air circulating pump are used to reduce the free moisture present in the semi purified coffee oil. The conical flask 1 is connected with the output valve of the circulating air pump and Conical flask 3 is connected with the inlet valve, by keeping Conical flask 2 in between, connected with both flasks 1 & 2. Conical flasks 1, 2 & 3 contain semi purified coffee oil, Anhydrous H₂SO₄ and Silica Gel beads (21) respectively. The Silica Gel (21) is introduced, and it neutralizes the presence of any minimal trace of acid fumes, if any, that are generated by the H₂SO₄, contained within Conical flask 2). After the completion of the final stage of water removal, and a sieve of the product through another fine mesh filter (13) above 600 mesh size, what remains in Conical flask 1 is a stabilized form of Pure Coffee Oil (PCO) (23) derived from Spent Coffee Ground (SCG).

The final stabilized form of Pure Coffee Oil (PCO) (23) derived possess the purity level of 99.80% with the presence of external particles in the minimal range of 0.10-0.15% and free moisture within the range of 0.05-0.35%.

Therefore, the present disclosure provides a process for purification of crude coffee oil (CCO) into Pure Coffee Oil (PCO) obtained from spent coffee grounds (SCG) comprising of the steps:
1. Decanting by heating of CCO at 35-45° C. for a period of 20-25 minutes in a conical flask, then placing the warm liquid in a separating funnel for a period of 22-24 hours, to obtain three separate layers of semi purified coffee oil, moisture and coffee dust and other solid particles like gum/wax etc. within the vessel;
2. Filtering the semi purified coffee oil through multiple mesh filters between 150 to 635 or up to 800 mesh size to facilitate the gradual separation and removal of the unwanted gummy, waxy and dusty particles of SCG, present in the liquid to produce semi purified coffee oil, and
3. Non thermal drying of filtered semi purified coffee oil by passing the semi purified coffee oil over concentrated anhydrous Sulphuric Acid (H₂SO₄) and Silica Gel to obtain the purified coffee oil.

100% pure H₂SO₄ can absorb moisture content equivalent to its weight, i.e. 100% and Silica Gel beads can absorb around 20-40% of its own weight in moisture. In this process, the Silica Gel is used as a support system to the non-thermal drying of the moisture in the coffee oil using anhydrous H₂SO₄. The Silica Gel is introduced, and it neutralizes the presence of any minimal trace of acid fumes, if any, that are generated by the H₂SO₄.

The present disclosure therefore provides a process for production of pure coffee oil from spent coffee ground comprising mechanical extraction of Crude Coffee Oil and purification of the crude coffee oil, into Pure Coffee Oil, wherein the mechanical extraction of crude coffee oil comprises of steps:
A. Reduction of moisture content of the raw material to obtain a SCG raw material having 19-26% moisture content, and
B. Extraction of the SCG raw material obtained at the end of step A to produce crude coffee oil;
wherein the step A reduction of moisture content of the raw material involves steps
   i. dewatering of SCG raw material having a moisture level of about 46-66% at a controlled pressure of about 200-400 bars for about 1 hour, to produce dewatered SCG raw material having 20-28% moisture content, and
   ii. drying of dewatered SCG raw material as obtained in step (i) at a minimal temperature of about 36-39° C. for about 60 minutes to produce dried SCG raw material having 19-26% moisture content; and
wherein the step B extraction of the SCG raw material involves compression of SCG raw material obtained at the end of step A at a pressure of about 400-600 bars and at a controlled temperature of 36-39° C.; and
wherein the pure coffee oil has a purity of 99.80%.

The present disclosure is now being illustrated by way of non-limiting examples. The examples are intended to be purely exemplary of the disclosure and should therefore not be considered to limit the disclosure in any way. Efforts have been made to ensure accuracy with respect to numbers used, but some experimental errors and deviations should be accounted for.

Raw Materials: Spent Coffee Grounds (SCG), a waste material, collected from Partnering Cafes, are stored in sealed containers, and kept in a cool, dry environment. These SCG are considered as the sourced raw material for the extraction of Crude Coffee Oil (CCO), to be processed as per the necessary, defined and determined guidelines, for a successful output yield from the SCG. The SCG raw material contains about 46-66% moisture, depending upon the method used in brewing the dry coffee bean grounds, e.g. Hot Brew, Cold Brew, French Press, Pour Over etc.

### Example 1: Mechanical Extraction Process of Coffee Oil

The wet SCG is filled up in a cotton bag, the dimensions of which are the same as the internal dimensions of the hydraulic machine's compression chamber.

### Dewatering

In a 10 Kgs batch size, on an average, moisture release by weight of approximately 2.5-3.5 Kgs occurs, depending on the dry/wet/black/brown raw material used. This process is continued for a minimum of 45 minutes and a maximum of 60 minutes, to not lose more than necessary amount of moisture from the Wet SCG (WSCG). At the end of the run, a 25-35% reduction in weight happens in the De-Watered SCG (DWSCG). Table 1 shows the data of dewatering performed on different samples.

TABLE 1
Moisture content of SCG after the step of dewatering
in the Mechanical Hydraulic Press.

| | | | D/W | | Moisture | Percentage |
|---|---|---|---|---|---|---|
| | | Material | Run | Post | Loss in | Moisture |
| | Sample | Type | Time | D/W - | D/W - (BY | Loss (%) |
| | size | BLACK/ | in | SCG | WEIGHT- | In |
| DEWATERING | (Kgs) | BROWN | Mins | (KGS) | Kgs) | Dewatering |
| 1 | 10 | Black | 45 | 6.93 | 3.07 | 30.7 |
| 2 | 10 | Black | 45 | 7.44 | 2.56 | 25.6 |
| 3 | 10 | Black | 45 | 6.465 | 3.54 | 35.35 |

The De-Watered liquid output—Coffee Water Solution (CWS)—is left in a specifically designed mild steel collection device called Dewatering Decanter, suitable for the purpose, for a minimum period of 10-12 hours to give the output material the necessary time to settle the moisture at the bottom of the device.

The top layer of the output, inside the collection device, is a concentrated form of crude called Coffee Water Solution (CWS), containing around 5-10% of Crude Coffee Oil (CCO).

### Drying

The Dewatered Spent Coffee Grounds (DWSCG) is then dried in a custom-made Tray Dryer for around 60 minutes at a minimal temperature of 36-39° C. to further reduce the moisture content and bring the raw material to the optimal levels of moisture.

The DWSCG is equally distributed amongst the 12 (Twelve) trays and spread out evenly on these specially designed & custom-made steel netted trays for the purpose (FIG. 3). Steel netted trays are used to allow the bottom layer of the DWSCG, spread on each tray, to receive the hot air circulation inside the dryer and in the process, evenly dry the material. If the material is extremely wet with higher than the standard range of moisture content, Tray positions are periodically interchanged to achieve a homogenous drying of the DWSCG after 30 minutes. The maximum temperature is set at 36-39° C. for the drying operation to run for 60 minutes. The relative (compared with the absolute weight of DWSCG) moisture loss here in the Tray Dried Spent Coffee Ground (TDSCG) is between 1.5-4.9% depending on multiple factors like the type of sample used, (Black Arabica/Brown Robusta), the method in which the coffee grounds were brewed, viz. Cold/Hot Brew etc., and relative atmospheric humidity. Table 2 shows the data of drying of dewatered SCG raw material performed on different samples.

TABLE 2
Moisture content of SCG after the step of drying at Tray Dryer

| | | | | | | | Relative | Absolute |
|---|---|---|---|---|---|---|---|---|
| | | | | | | | (DWSCG | (Batch |
| | | | | | | | size) | Size) |
| | | | | | | Moisture | Percentage | Percentage |
| | | Material | T/D | | Post | Loss in | Moisture | Moisture |
| | Sample | Type | Time | Post | D/W - | T/D - (BY | Loss (%) | Loss (%) |
| TRAY | size | BLACK/ | in | T/D - | SCG | WEIGHT - | In Tray | In Tray |
| DRYING | (Kgs) | BROWN | Mins | KGS | (KGS) | Kgs) | Drying | Drying |
| 1 | 10 | Black | 60 | 7.33 | 7.44 | 0.11 | 1.5 | 1.1 |
| 2 | 10 | Black | 60 | 6.17 | 6.475 | 0.305 | 4.94 | 3.05 |
| 3 | 10 | Brown | 60 | 7.03 | 7.265 | 0.235 | 3.34 | 2.35 |

### Extraction Process

On completion of the first 2 steps—1) Dewatering & 2) Drying—of preparing & making the WSCG ready for the extraction of CCO from it, the TDSCG having an optimal moisture content, is compressed in a custom built Mechanical Hydraulic Press Machine with appropriate hydraulic pressure, and long slotted container, necessary for yielding the output of CCO. The pressure used in the machine at this point is between 400-600 bars and a controlled temperature of 36-39° C.

The TDSCG is filled in a cotton bag made using 450-600 GSM cloth studded with 2-3 layers of horizontal rubber-flexible pipes of multiple varieties, stitched onto a nylon net, with holes running end to end in layers. The layers of horizontal pipes are inserted inside the bag, housed within the TDSCG, thus dividing the entire bag into 3-4 horizontal sections. The pipes function as a medium of channel and strainer for the CCO to be discharged at the end of the inner vertical side of the cotton bag, from where it seeps out from the bag and through the slotted wall of the compression chamber. The perforated pipes enable the CCO to channel through the material, along with the water, and be expelled into the output tray, in a resistance free flow rate.

After the load, the pressure in the hydraulic chamber is raised by releasing the hydraulic oil inside the bottom of the hydraulic cylinder. The piston-compression plate sub-assembly is slowly pushed upward, compressing the cotton bag containing the TDSCG. When the hydraulic pressure rises above 400-450 bars, CCO starts getting discharged through the slotted walls of the compression chamber.

Each run in the Hydraulic press is executed for about 60-120 minutes; 3-4 such extraction runs are necessary to yield the maximum possible output of CCO, using a mechanical press method.

Each time the DFSCG is brought out of the machine and prepared for the following extraction run, the visible oil quantity is assessed by measuring the balance weight of the DFSCG. Until the final weight of the Defatted SCG (DFSCG) has not reduced from the batch size of 10 Kgs to an average of 4-4.5 Kgs, it is an indicator that some quantum of CCO is remaining to be extracted from it. Once that has been assessed and ascertained, the DFSCG is taken out of the machine by first lowering the hydraulic pressure, then raising the piston-pressure plate and finally removing the bag containing the DFSCG.

Table 3 shows the yield of CCO at wet and dry basis after the process of extraction has been performed. At the end of cycles maximum possible output of CCO as obtained from the mechanical hydraulic press machine is about 6.24-7.40% on a wet weight basis and about 8.94-10.24% on a dry weight basis.

TABLE 3
Yield of CCO on wet and dry weight basis

| YIELD | | Sample | | | | |
|---|---|---|---|---|---|---|
| OF CCO | Material | size | DEWATERED | | | |
| ON WET | Type | (Kgs) - | AND TRAY | Quantity | % YIELD | % YIELD |
| AND DRY | BLACK/ | WET | DRIED | OF CCO | ON WET | ON DRY |
| WEIGHT | BROWN | WEIGHT | WEIGHT | in ml | WEIGHT | WEIGHT |
| 1 | Brown | 10 | 6.98 | 624 | 6.24 | 8.94 |
| 2 | Brown | 10 | 7.055 | 700 | 7 | 9.92 |
| 3 | Brown | 10 | 7.225 | 740 | 7.4 | 10.24 |

### Example 2: Purification and Stabilization of Crude Coffee Oil

### Decantation

At the beginning of the purification process, the liquid output received from the steps of extraction, including Dewatering and Extraction via multiple runs of various time durations, is heated at 35-45° C. (Thirty Five to Forty Five Degrees Celsius) for a brief period of 20-25 minutes. The output attains a certain specific consistency with the above process, preparing it for the decantation phase. In this phase, the warm CCO is placed in a Separating Funnel for 22-24 (Twenty Two to Twenty Four) hours approximately for enabling the settlement and separation of Oil, Moisture and the other solid, wax/gum like particles. After this settlement period, the 3 (Three) layers are clearly distinguishable within the Separating Funnel. To make the CCO ready for further purification, the 2 (two) separated and unwanted layers (moisture & solid like particles) are carefully discarded from the Separating Funnel. Only the semi-purified coffee oil is retained for running the subsequent processes henceforth.

### Filtration Process

The collected semi purified coffee oil at this stage consists of 4-7% (Four to Seven percentage) of free moisture, 2-4% (Two to Four percentage) of gum & wax, and 1-3% (One to Three percentage) of coffee dust particles. The balance liquid contains 86-92% (Eighty Six to Ninety Two percentage) of semi purified Coffee Oil.

At this stage, when the output has been largely purified of its heavy moisture and bigger solid particles, Filtration of the finer particles become necessary to attain the next level of purity, before deriving the final product through additional processes of purification. Filtration is a 3-4 step process, in which multiple mesh filters between 150 to 635 sizes are used in an ascending order, in conjunction with pressure conditions, to facilitate the gradual separation and removal of the unwanted gummy, waxy and dusty particles of SCG, present in the liquid. The coffee dust particles and some of the gummy substance gets separated from the oil while passing through lower sized meshes. The wax and remaining gummy substance get removed when passed through the higher sized meshes.

### Non-Thermal Drying Process

After the Decantation & Filtration stages have been completed, the semi-purified oil consists of 4-7% (Four to Seven percentage) of free moisture, 0.15-0.25% (Zero point One Five to Zero point Two Five percentage) of gum & wax, and 0.10-0.30% (Zero point One Zero to Zero point Three Zero percentage) of fine coffee dust particles. The balance liquid contains 92-95% (Ninety Two to Ninety Five percentage) of semi purified Coffee Oil. In the non-thermal drying process using H2So4, a closed-circuit drying unit comprising of 3 conical flasks and an air circulating pump are used to reduce the free moisture present in the semi purified coffee oil, within the acceptable limit of 0.25-0.35% (Zero point Two Five to Zero point Three Five percentage).

The conical flask 1 is connected with the output valve of the circulating air pump and Conical flask 3 is connected with the inlet valve, by keeping Conical flask 2 in between, connected with both flasks 1 & 3. Conical flasks 1, 2 & 3 contain 500 ml semi purified coffee oil, 200-250 ml Anhydrous H₂SO₄ and 100 gm Silica Gel beads. The Silica Gel is introduced, and it neutralizes the presence of any minimal trace of acid fumes, if any, that are generated by the H₂SO₄, contained within Conical flask 2).

The drying process is carried out for approximately 80 to 110 minutes, depending on the raw material used for extracting the CCO. After the completion of the final stage of water removal, and a sieve of the product through another fine filter above 600/800 mesh size, the process leads to a Coffee Oil purity of 99.80% with the presence of external particles in the minimal range of 0.10-0.15% and free moisture within the range of 0.05-0.35%. What remains in Conical flask 1 is a stabilized form of Pure Coffee Oil (PCO) derived from Spent Coffee Grounds (SCG).

Table 4 shows the yield of Pure Coffee Oil (PCO) as obtained from CCO after performing the three stages of purification.

TABLE 4
Yield of PCO on wet and dry weight basis

| YIELD | | Sample | | | | |
|---|---|---|---|---|---|---|
| OF PCO | Material | size | DEWATERED | | | |
| ON WET | Type | (Kgs) - | AND TRAY | Quantity | % YIELD | % YIELD |
| AND DRY | BLACK/ | WET | DRIED | OF PCO | ON WET | ON DRY |
| WEIGHT | BROWN | WEIGHT | WEIGHT | in ml | WEIGHT | WEIGHT |
| 1 | Black | 10 | 5.4 | 193 | 1.93 | 3.57 |
| 2 | Black | 10 | 6.04 | 247 | 2.47 | 4.09 |
| 3 | Black | 10 | 6.225 | 233 | 2.33 | 3.74 |

The present disclosure is not to be limited in scope by the specific embodiments described herein. Indeed, various modifications of the disclosure, in addition to those described herein, will become apparent to those skilled in the art from the foregoing description and accompanying figures. Such modifications are intended to fall within the scope of the appended claims. The disclosure is, therefore, to be limited only by the terms of the appended claims along with the full scope of equivalents to which the claims are entitled.

What is claimed is:

1. A method for extraction of Crude Coffee Oil (CCO) from Spent Coffee Ground (SCG) using a Mechanical Hydraulic Press Machine, the method comprising the steps of:
a. reducing moisture content of the raw material to obtain a SCG raw material having 19-26% moisture content; and
b. extracting the SCG raw material obtained at the end of step (a) to produce crude coffee oil;
wherein extraction of the SCG raw material involves compression of SCG raw material obtained at the end of step (a) at a pressure of about 400-600 bars and at a temperature of 36-39° C.

2. The method according to claim 1, wherein the step (a) of reducing moisture content of the raw material comprises:
i. dewatering of SCG raw material having a moisture level of about 46-66% at a controlled pressure of about 200-400 bars for about 60 mins, to produce dewatered SCG raw material having 20-28% moisture content, and
ii. drying of dewatered SCG raw material as obtained in step (i) at a temperature of about 36-39° C. for about 60 minutes to produce Tray Dried SCG (TDSCG) raw material having 19-26% moisture content.

3. The method according to claim 1, wherein step (b) of extracting the SCG raw material is carried out for 3-4 cycles, and each cycle has a time period of 60-120 minutes.

4. The method according to claim 3, wherein the pressure is reduced to zero at each cycle at every 20-25 minutes.

5. The method according to claim 1, wherein the crude coffee oil is purified to obtain pure coffee oil.

6. The method according to claim 5, wherein the crude coffee oil is purified by a method comprising the steps of:
i. decanting by heating of CCO at 35-45° C. for a period of 20-25 minutes, to obtain three separate layers of semi purified coffee oil, moisture and coffee dust and other semi-soling gum/wax particles within the vessel;
ii. filtering the semi purified coffee oil through multiple mesh filters having mesh size between 150 to 800 to produce semi purified coffee oil; and
iii. non thermal drying of filtered semi purified coffee oil by passing the semi purified coffee oil over concentrated anhydrous sulphuric acid (H₂SO₄) and silica gel to obtain the purified coffee oil.

7. A method for production of pure coffee oil (PCO) from spent coffee ground (SCG) the method comprising the steps of:
a. reducing moisture content of the raw material to obtain a SCG raw material having 19-26% moisture content;
b. extracting the SCG raw material obtained at the end of step (a) to produce Crude Coffee Oil (CCO); and
c. purifying the crude coffee oil (CCO) to obtain pure coffee oil (PCO);
wherein extraction of the SCG raw material involves compression of SCG raw material obtained at the end of step (a) at a pressure of about 400-600 bars and at a temperature of 36-39° C.

8. The method according to claim 7, wherein the step (a) of reducing moisture content of the raw material comprises:
i. dewatering of SCG raw material having a moisture level of about 46-66% at a controlled pressure of about 200-400 bars for about 60 minutes, to produce dewatered SCG raw material having 20-28% moisture content; and
ii. drying of dewatered SCG raw material as obtained in step (i) at a temperature of about 36-39° C. for about 60 minutes to produce dried SCG raw material having 19-26% moisture content.

9. The method according to claim 7, wherein step (b) of extracting crude coffee oil from the SCG raw material is carried out for 3-4 cycles.

10. The method according to claim 9, wherein the pressure is reduced to zero at each cycle at every 20-25 minutes.

11. The method according to claim 7, wherein the method for purification of crude coffee oil comprises the steps of:
i. decanting by heating of CCO at 35-45° C. for a period of 20-25 minutes to obtain three separate layers of semi purified coffee oil, moisture and coffee dust particles within the vessel;
ii. filtering the semi purified coffee oil through multiple mesh filters having mesh size between 150 to 800 to produce semi purified coffee oil; and
iii. non thermal drying of filtered semi purified coffee oil by passing the semi purified coffee oil over concentrated anhydrous sulphuric acid (H₂SO₄) and silica gel to obtain the purified coffee oil.
